(19) United States
(12) Patent Application Publication
(10) Pub. No.: US 2019/0022857 A1
(43) Pub. Date: Jan. 24, 2019

(54) CONTROL APPARATUS AND CONTROL METHOD

(71) Applicant: SONY CORPORATION, Tokyo (JP)

(72) Inventors: William Alexandre CONUS, Kanagawa (JP); Yasuhisa Kamikawa, Tokyo (JP); Wataru Kokubo, Tokyo (JP)

(73) Assignee: SONY CORPORATION, Tokyo (JP)

(21) Appl. No.: 16/087,142

(22) PCT Filed: Feb. 2, 2017
(86) PCT No.: PCT/JP2017/003844

§ 371 Date: Sep. 21, 2018

(30) Foreign Application Priority Data
Mar. 31, 2016 (JP) 2016-070595

(51) Int. Cl. B25J 9/16; G06F 9/54; G06F 15/18

(52) U.S. Cl. CPC B25J 9/163; B25J 9/1651; G06F 15/18; G06F 9/542; B25J 9/1676

(57) ABSTRACT

[Object] To provide a technology capable of obtaining information for controlling the movements of a robot more appropriately.

[Solution] Provided is a control apparatus including: a control section that infers an intention of an external force on a basis of the external force.

### TECHNICAL FIELD

The present disclosure relates to a control apparatus and a control method.

### BACKGROUND ART

Recently, technologies that cause a robot to move safely on the basis of a result of monitoring the robot have been disclosed. For example, a technology that estimates an external force acting on a robot from an external environment, and causes the robot to stop in a case in which the estimated external force satisfies a predetermined condition has been disclosed (for example, see Patent Literature 1).

### CITATION LIST

### Patent Literature

Patent Literature 1: JP 2015-208834A

### DISCLOSURE OF INVENTION

### Technical Problem

However, it is important to obtain information for controlling the movements of a robot more appropriately. Accordingly, the present disclosure provides a technology capable of obtaining information for controlling the movements of a robot more appropriately.

### Solution to Problem

According to the present disclosure, there is provided a control apparatus including: a control section that infers an intention of an external force on a basis of the external force.

In addition, according to the present disclosure, there is provided a control method including: inferring, by a processor, an intention of an external force on a basis of the external force.

### Advantageous Effects of Invention

According to the present disclosure as described above, it is possible to obtain information for controlling the movements of a robot more appropriately. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating an exemplary configuration of an endoscopic surgery system according to the present embodiment.

FIG. 2 is a block diagram illustrating an example of a functional configuration of a support system according to the present embodiment.

FIG. 3 is a diagram for explaining an overview of the functions of a control section.

FIG. 4 is a diagram for explaining an example of an external force not intentional for surgery.

FIG. 5 is a diagram for explaining an example of an external force not intentional for surgery.

FIG. 6 is a diagram for explaining an example of an external force not intentional for surgery.

FIG. 7 is a flowchart illustrating an example of overall operations of the control section.

FIG. 8 is a flowchart illustrating a detailed example of operations from a state in which an arm section is stopped to a state in which the arm section is moving.

FIG. 9 is a diagram illustrating an example of a case in which the change in the magnitude of an external force is gradual.

FIG. 10 is a diagram illustrating an example of a case in which the change in the magnitude of an external force is non-gradual.

FIG. 11 is a diagram illustrating an example of a case in which the change in the direction of an external force is gradual.

FIG. 12 is a diagram illustrating an example of a case in which the change in the direction of an external force is non-gradual.

FIG. 13 is a flowchart illustrating a detailed example of operations from a state in which an arm section is moving to a state in which the arm section is stopped.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order.

1. Configuration of endoscopic surgery system

2. Configuration of support system

3. Supplement

Note that the following describes a preferred embodiment of the present disclosure by taking, as an example, a case in which the present technology is applied to an endoscopic surgery system. However, the present technology is not limited to such an example, and is also applicable to medical procedures (such as various types of examinations and surgeries) performed with a surgical instrument (observation instrument and/or treatment tool) supported by a support arm apparatus. Also, in the following description, “user” is assumed to mean at least one member of the medical staff (such as a surgeon who performs surgery, a scopist who operates the endoscope, and an assistant) who use the endoscopic surgery system. The user will be described as the surgeon, the scopist, or the like only in cases where it is necessary to distinguish the user in particular.

### (1. Configuration of Endoscopic Surgery System)

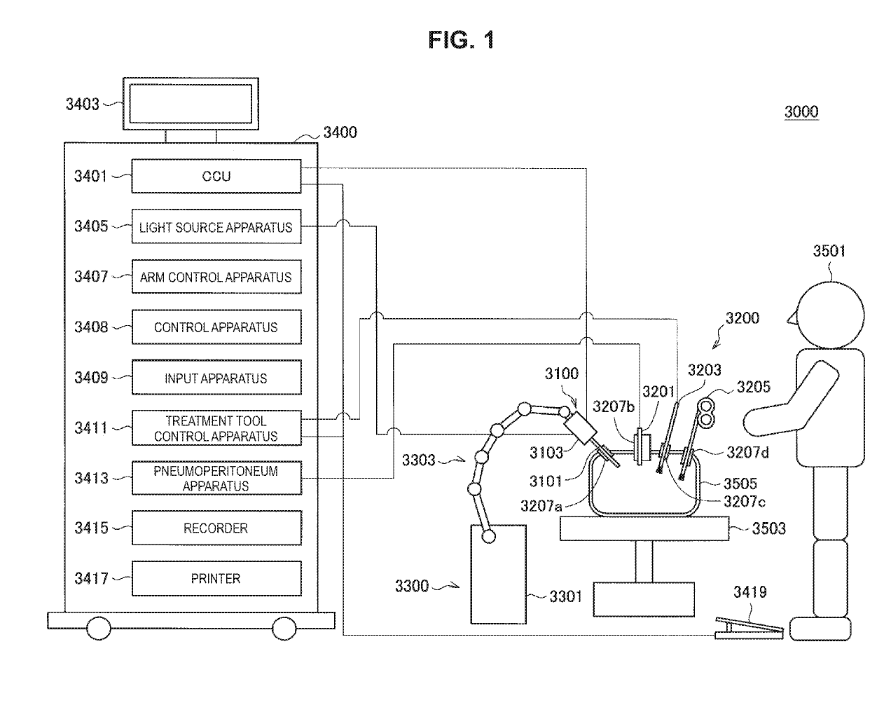

FIG. 1 will be referenced to describe a configuration of an endoscopic surgery system to which the support system according to the present embodiment may be applied. FIG. 1 is a diagram illustrating an exemplary configuration of an endoscopic surgery system according to the present embodiment.

FIG. 1 illustrates a situation in which a surgeon (doctor) 3501 is using an endoscopic surgery system 3000 to perform surgery on a patient 3505 lying on a patient bed 3503. As illustrated in the diagram, the endoscopic surgery system 3000 includes an endoscope 3100, other surgical instruments 3200, a support arm apparatus 3300 that supports the endoscope 3100, and a cart 3400 on which various apparatus for endoscopic surgery are provided. By applying the support system according to the present embodiment to the endoscopic surgery system 3000, safer surgery may be realized.

In endoscopic surgery, instead of opening up the abdomen by cutting the abdominal wall, tubular hole-opening tools called trocars 3207a to 3207d are used to puncture the abdominal wall in multiple places. Subsequently, the lens tube 3101 of the endoscope 3100 and other surgical instruments 3200 are inserted into the body cavity of the patient 3505 from the trocars 3207a to 3207d. In the illustrated example, a pneumoperitoneum tube 3201, an energy treatment tool 3203, and forceps 3205 are inserted into the body cavity of the patient 3505 as the other surgical instruments 3200. The energy treatment tool 3203 is a treatment tool that makes incisions into and ablates tissues, or seals blood vessels or the like, with a high-frequency electric current or ultrasonic vibration. However, the surgical instruments 3200 illustrated in the diagram are merely an example, and any of various types of surgical instruments typically used in endoscopic surgery, such as tweezers and retractors, for example, may also be used as the surgical instruments 3200.

An image of the operating site inside the body cavity of the patient 3505 taken by the endoscope 3100 is displayed on a display apparatus 3403 described later. The surgeon 3501 uses the energy treatment tool 3203 and the forceps 3205 to perform treatments, such as excising an affected area, for example, while watching in real time the image of the operating site displayed on the display apparatus 3403.

Note that, although omitted from the diagram, the pneumoperitoneum tube 3201, the energy treatment tool 3203, and the forceps 3205 are supported by a person such as the surgeon 3501 or an assistant during surgery. Alternatively, although only one support arm apparatus 3300 that supports the endoscope 3100 is provided in the example illustrated in the diagram, multiple support arm apparatus 3300 may also be provided, and the pneumoperitoneum tube 3201, the energy treatment tool 3203, and the forceps 3205 may be supported by each of the multiple support arm apparatus 3300.

### (Support Arm Apparatus)

The support arm apparatus 3300 is provided with an arm section 3303 that extends from a base section 3301. In the illustrated example, the arm section 3303 is driven by control from an arm control apparatus 3407. The endoscope 3100 is supported by the arm section 3303, with the position and attitude controlled thereby. With this arrangement, locking of the endoscope 3100 in a stable position may be realized.

### (Endoscope)

The endoscope 3100 includes a lens tube 3101 having a region of certain length from the front end that is inserted into the body cavity of the patient 3505, and a camera head 3103 connected to the base end of the lens tube 3101. The endoscope 3100 is what is called a rigid scope having a rigid lens tube 3101. However, the present embodiment is not limited to such an example, and the endoscope 3100 may also be configured as what is called a flexible scope having a flexible lens tube 3101.

On the front end of the lens tube 3101, there is provided an opening into which an objective lens is fitted. The endoscope 3100 is configured as a forward-viewing scope in which the objective lens is disposed so that the extension direction of the lens tube 3101 and the optical axis are approximately aligned. A light source apparatus 3405 described later is connected to the endoscope 3100. Light generated by the light source apparatus 3405 is guided up to the front end of the lens tube by a light guide extending inside the lens tube 3101, and is radiated through the objective lens towards an observation target inside the body cavity of the patient 3505. Note that the present embodiment is not limited to such an example, and the endoscope 3100 may also be an oblique-viewing scope or a side-viewing scope.

An optical system and an image sensor are provided inside the camera head 3103, and reflected light (observation light) from the observation target is condensed onto the image sensor by the optical system. Observation light is photoelectrically converted by the image sensor, and an electrical signal corresponding to the observation light, or in other words, an image signal corresponding to the observed image, is generated. The image signal is transmitted as RAW data to a camera control unit (CCU) 3401 described later. Note that the camera head 3103 may be provided with a function of adjusting the magnification and the focal length by appropriately driving the optical system.

Note that in the present embodiment, to support stereoscopic vision (3D display) or the like, multiple image sensors are provided in the camera head 3103. In other words, the endoscope 3100 may be configured as a stereo camera. In this case, multiple relay optical subsystems are provided inside the lens tube 3101 to guide the observation light to each of the multiple image sensors. However, the present embodiment is not limited to such an example, and the endoscope 3100 may also be configured so that the camera head 3103 includes a single image sensor.

### (Various Apparatus Provided on Cart)

The CCU 3401 includes a processor such as a central processing unit (CPU) or a graphics processing unit (GPU), and centrally controls the operation of the endoscope 3100 and the display apparatus 3403. Specifically, the CCU 3401 subjects an image signal received from the camera head 3103 to various types of image processing for displaying an image based on the image signal, such as a development process (demosaicing process), for example. The CCU 3401 provides an image signal that has been subjected to such image processing to the display apparatus 3403. Also, the CCU 3401 transmits a control signal to the camera head 3103 to control the driving thereof. The control signal may include information related to imaging conditions, such as the magnification and the focal length.

The display apparatus 3403, under control by the CCU 3401, displays an image based on an image signal subjected to image processing by the CCU 3401. In a case in which the endoscope 3100 supports imaging at a high resolution such as 4K or 8K, and/or supports 3D display, for example, an apparatus compatible with each and capable of high-resolution display and/or capable of 3D display may be used as the display apparatus 3403. Also, the display apparatus 3403, in accordance with an instruction from a control apparatus 3408 described later, displays a warning regarding the operation of the endoscope 3100 by the scopist, in a format such as text, for example.

The light source apparatus 3405 includes a light source such as a light-emitting diode (LED), for example, and supplies the endoscope 3100 with irradiating light when imaging the operating site.

The arm control apparatus 3407 includes a processor such as a CPU, for example, and by operating in accordance with a predetermined program, controls the driving of the arm section 3303 of the support arm apparatus 3300 in accordance with a predetermined control method. Note that since any of various known types of methods can be applied as the specific method by which the arm control apparatus 3407 controls the driving of the arm section 3303, a detailed description thereof is omitted herein.

The control apparatus 3408 includes a processor such as a CPU, for example, and cooperates with the CCU 3401 and the arm control apparatus 3407 to execute various types of controls for supporting operations by the scopist in surgeries using the endoscopic surgery system 3000, with the objective of ensuring safety. Details regarding the functions of the control apparatus 3408 will be described further in (2. Configuration of support system) below.

The input apparatus 3409 is an input interface with respect to the endoscopic surgery system 3000. Through the input apparatus 3409, the user is able to input various information and instructions into the endoscopic surgery system 3000. For example, through the input apparatus 3409, the user inputs various information related to surgery, such as physical information about the patient, and information about surgical procedures. As another example, through the input apparatus 3409, the user inputs instructions to drive the arm section 3303, instructions to change the imaging conditions of imaging by the endoscope 3100 (such as the type of irradiating light, the magnification, and the focal length), and the like. Also, through the input apparatus 3409, the user is able to input various types of information (such as the motion-restricting information described later) processed in the support system.

The type of the input apparatus 3409 is not limited, and the input apparatus 3409 may be any of various known types of input apparatus. For example, a mouse, a keyboard, a touch panel, a switch, the footswitch 3419, and/or a lever and the like may be applied as the input apparatus 3409. In the case in which a touch panel is used as the input apparatus 3409, the touch panel may be provided on the display screen of the display apparatus 3403.

Alternatively, the input apparatus 3409 may be a device worn by the user, such as an eyeglasses-style wearable device or a head-mounted display (HMD), for example, and various types of input may be performed in accordance with the user's gestures or gaze motions, head tracking, or the like detected by these devices. Alternatively, the input apparatus 3409 may be a camera capable of detecting motions of the user. Various types of input may be performed in accordance with the user's gestures or gaze detected from a picture imaged by the camera. Alternatively, the input apparatus 3409 may be a microphone capable of picking up the user's speech. Various types of input may be performed by speech through the microphone. In this way, by configuring the input apparatus 3409 to be capable of accepting the input of various types of information in a non-contact manner, a user belonging to a clean area in particular (for example, the surgeon 3501) becomes able to operate equipment belonging to an unclean area in a non-contact manner. Also, since the user becomes able to operate equipment without taking one's hands away from the tools the user is holding, user convenience is improved.

A treatment tool control apparatus 3411 controls the driving of the energy treatment tool 3203 to cauterize or make incisions into tissue, seal blood vessels, or the like. A pneumoperitoneum apparatus 3413 delivers gas into the body cavity through the pneumoperitoneum tube 3201 to inflate the body cavity of the patient 3505 for the purpose of securing a field of view for the endoscope 3100 and securing a workspace for the surgeon 3501. A recorder 3415 is an apparatus capable of recording various types of information related to surgery. A printer 3417 is an apparatus capable of printing out various types of information related to surgery in various formats, such as text, images, or graphs.

The above describes the configuration of the endoscopic surgery system 3000.

### (2. Configuration of Support System)

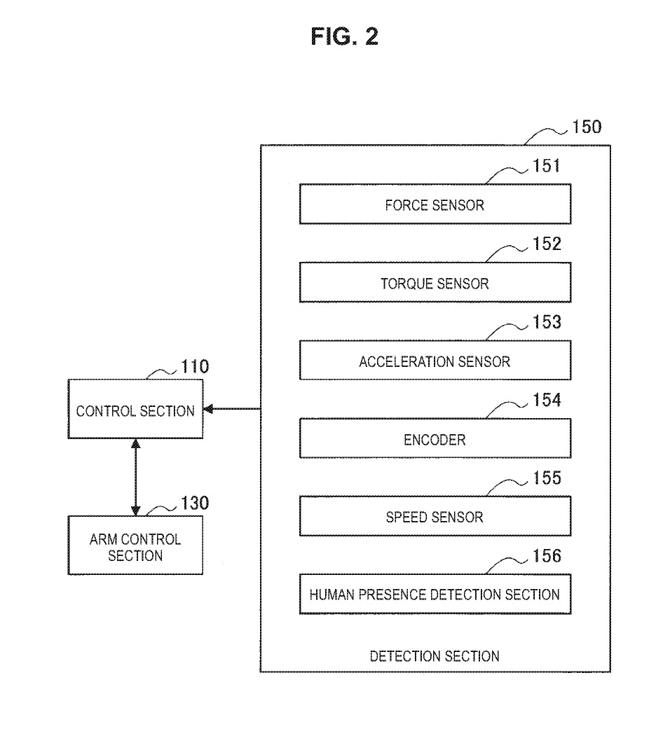

FIG. 2 will be referenced to describe a configuration of the support system according to the present embodiment, which is applied to the endoscopic surgery system 3000 described above. FIG. 2 is a block diagram illustrating an example of a functional configuration of the support system according to the present embodiment. Note that the support system according to the present embodiment supports the user who operates surgical instruments supported by the support arm apparatus through the support arm apparatus during examinations and surgeries. The present embodiment is described by taking as an example a case in which, when the scopist operates the endoscope while moving the arm section of the support arm apparatus by a direct operation, the support system supports the operations of the scopist. However, the present embodiment is not limited to such an example, and in the case in which another surgical instrument supported by the support arm apparatus is operated by another user, the support system may also support the operation of the other surgical instrument by the other user.

Referring to FIG. 2, the support system 1 according to the present embodiment is provided with a control section 110, an arm control section 130, and a detection section 150 as functions thereof.

The detection section 150 is provided with a force sensor 151, a torque sensor 152, an acceleration sensor 153, an encoder 154, a speed sensor 155, and a human presence detection section 156. The force sensor 151 detects a force acting on each joint section of the support arm apparatus 3300. Also, the torque sensor 152 detects a torque acting on each joint section of the support arm apparatus 3300. The acceleration sensor 153 detects an acceleration induced in each link of the support arm apparatus 3300. The encoder 154 detects a rotational angle of each joint section of the support arm apparatus 3300. The speed sensor 155 detects a speed induced in each link of the support arm apparatus 3300.

Note that this specification primarily describes an example in which the arm section 3303 includes multiple links or multiple joint sections, and discrete sensors are provided in each of the multiple links or multiple joint sections. However, it is sufficient for the arm section 3303 to include multiple links or multiple joint sections, and for a sensor to be provided in at least the front end of the multiple links or the multiple joint sections.

The human presence detection section 156 detects a human being present in the surrounding area. For example, the specific type of sensor included in the human presence detection section 156 is not particularly limited. For example, the human presence detection section 156 may include a temperature sensor, an infrared sensor, or a measuring instrument that measures a change in a flow of current or electrical resistance when touched by a human being. Alternatively, the human presence detection section 156 may include a visible light camera or a high-frequency sensor.

The functions of the arm control section 130 may be realized by the arm control apparatus 3407 illustrated in FIG. 1. The arm control section 130 controls the position, attitude, and motion of the endoscope 3100 by controlling the driving of the arm section 3303 in the support arm apparatus 3300 in response to information indicating the state of each joint section provided from the support arm apparatus 3300, and operation input by the scopist. At this time, in the present embodiment, the arm control section 130 drives the arm section 3303 in accordance with the control by the control section 110.

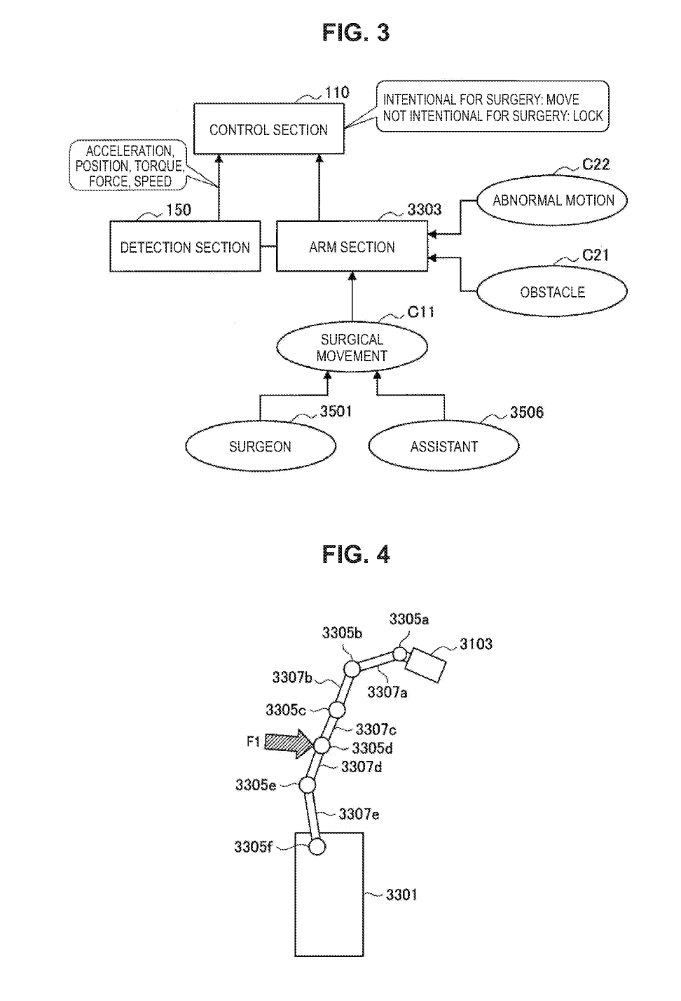

The functions of the control section 110 may be realized by the control apparatus 3408 illustrated in FIG. 1. An overview of the functions of the control section 110 will be described with reference to FIG. 3. FIG. 3 is a diagram for explaining an overview of the functions of the control section 110 of the present disclosure. As illustrated in FIG. 3, when an operation is performed on the arm section 3303 by the surgeon 3501, an assistant 3506, and the like, a surgical movement C11 of the arm section 3303 is performed. At this time, the control section 110 determines, from a result of detection by the detection section 150, that the external force occurring in the arm section 3303 is intentional for surgery, and causes the arm section 3303 to move.

On the other hand, as illustrated in FIG. 3, if an abnormal motion C22 is imparted or an obstacle C21 is contacted with respect to the arm section 3303, the control section 110 determines, from a result of detection by the detection section 150, that the external force occurring in the arm section 3303 is not intentional for surgery, and locks (stops) the arm section 3303. In this way, the control section 110 infers the intention of an external force on the basis of a result of detection by the detection section 150, or in other words, the external force on the arm section 3303 (hereinafter also simply called the “external force”). According to such a configuration, it becomes possible to obtain information for controlling the movements of the arm section 3303 more appropriately.

Furthermore, the control section 110 controls whether to move or stop the arm section 3303 on the basis of the inferred intention. Subsequently, the arm control section 130 drives the arm section 3303 in accordance with the control by the control section 110. With this arrangement, the movements of the arm section 3303 are controlled more appropriately. Herein, the type of external force is not particularly limited. For example, the external force may include at least one of a force, a torque, an acceleration, and a speed.

Note that a force preferably is detected by the force sensor 151. Also, a torque preferably is detected by the torque sensor 152. An acceleration may be detected by an acceleration sensor, or may be computed from an encoder detection result (the rotational angle of each joint section of the support arm apparatus 3300). Also, a speed may be detected by a speed sensor, or may be computed from an encoder detection result (the rotational angle of each joint section of the support arm apparatus 3300).

The above describes an overview of the functions of the control section 110. Next, an example of an external force not intentional for surgery will be described with reference to FIGS. 4 to 6. FIGS. 4 to 6 are diagrams for explaining an example of an external force not intentional for surgery. First, the configuration of the arm section 3303 will be described briefly with reference to FIG. 4. As illustrated in FIG. 4, the arm section 3303 includes joint sections 3305a to 3305f and links 3307a to 3307e. Note that although this specification describes an example in which the arm section 3303 includes five links and six joint sections, the respective numbers of links and joint sections are not particularly limited.

The joint sections 3305a to 3305f are provided with actuators, and the joint sections 3305a to 3305f are configured to be rotatable about a certain rotation axis in accordance with the driving of the actuators. By controlling the driving of the actuators with the arm control apparatus 3407, the rotational angle of each of the joint sections 3305a to 3305f is controlled, and the driving of the arm section 3303 is controlled. With this arrangement, the position and the attitude of the endoscope 3100 are controlled.

Specifically, the actuators provided in the joint sections 3305a to 3305f are provided with various types of sensor for detecting the state of each joint section, such as encoders that detect the rotational angle of each joint section, and torque sensors that detect the torque acting on each joint section. The detection values of these sensors are transmitted to the control section 110. The control section 110 includes an internal model in which the geometric state and the mechanical state of the arm section 3303 are expressed by internal coordinates of the support arm apparatus 3300, and on the basis of the internal model and detection values from the sensors, the control section 110 is able to grasp the current state of the joint sections 3305a to 3305f, that is, the current state (such as the position, attitude, and speed) of arm section 3303. The arm control apparatus 3407 computes, on the basis of the grasped state of the arm section 3303, drive control quantities (for example, the rotational angle and the driving torque) of each joint section corresponding to operation input with respect to the motion of the arm section 3303 from the user, and drives each joint section in accordance with the drive control quantities.

In the present embodiment, the arm control apparatus 3407 controls the driving of the arm section 3303 by force control. In the case in which force control is applied, the arm control apparatus 3407, in response to an operation performed by the doctor (scopist) who operates the endoscope 3100 directly touching the arm section 3303 or the endoscope 3100 (hereinafter also designated a direct operation), is able to execute what is called power assist control, in which the actuators of each of the joint sections 3305a to 3305c are driven so that the arm section 3303 moves smoothly following the external force from the direct operation. With this arrangement, when the scopist moves the arm section 3303 while touching the arm section 3303 directly, the arm section 3303 can be moved with comparatively light force. Consequently, it becomes possible to move the endoscope 3100 more intuitively with a simpler operation, and convenience for the scopist can be improved.

FIG. 4 illustrates an example in which a force stronger than a predetermined force occurs at a position close to the base section 3301 (for example, in the range from the links 3307c to 3307e) among the arm section 3303. In such a case, the control section 110 preferably determines that the force is not intentional for surgery, and stops the arm section 3303. Note that the position close to the base section 3301 is not particularly limited, and is sufficiently a position which has a low probability of being touched directly when a scopist operates the arm section 3303. Also, the magnitude of the predetermined force also is not particularly limited.

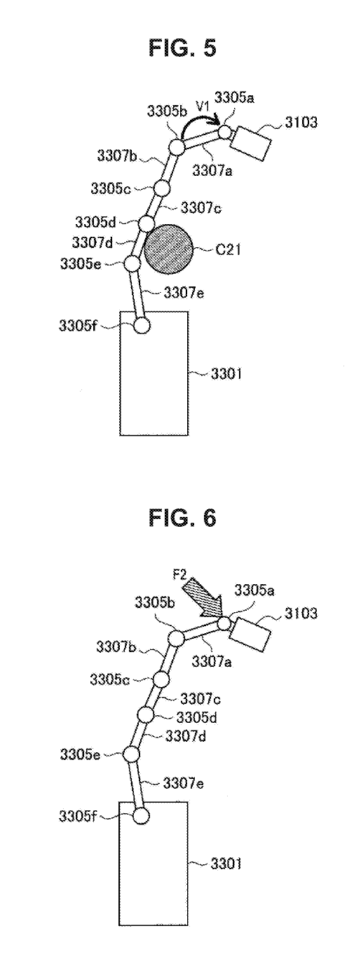

FIG. 5 illustrates a state in which, among the arm section 3303, the link 3307a on the front end is being moved in a direction V1 due to an operation by the scopist, but on the other hand, the arm section 3303 is colliding with an obstacle C21. In such a case, the control section 110 determines that an abnormal state has occurred, and may stop the arm section 3303, or control the arm section 3303 such that the arm section 3303 does not contact the obstacle C21.

FIG. 6 illustrates a state in which, among the arm section 3303, a force F2 is suddenly imparted to the link 3307a on the front end due to an operation by the scopist. In such a case, the control section 110 preferably stops the arm section 3303 in order to prevent endangering the patient.

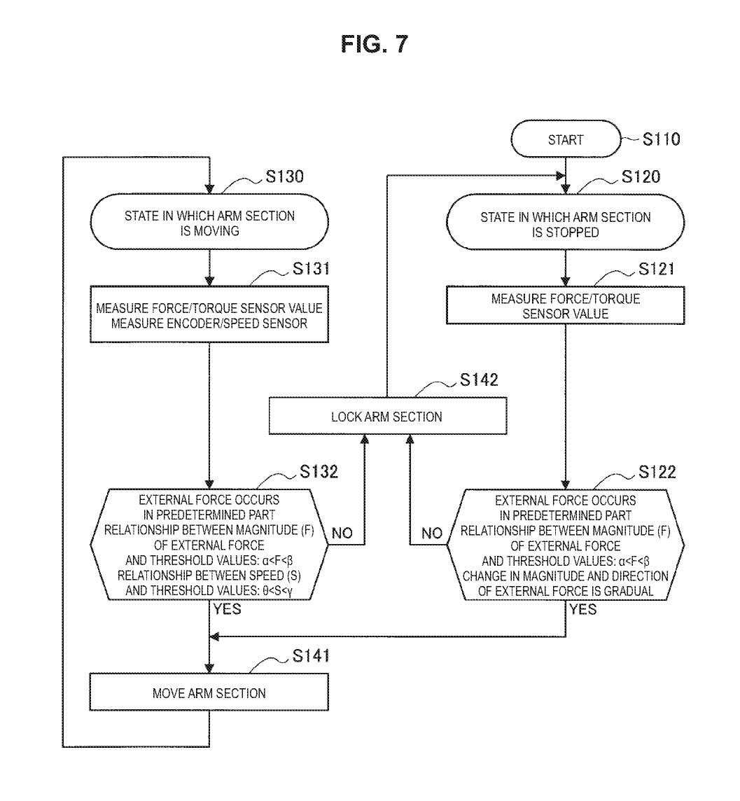

Next, details about the functions of the control section 110 will be described. FIG. 7 is a flowchart illustrating an example of overall operations of the control section 110. Note that in the conditional statements in the following flowchart, instead of force being used in the conditional judgment, acceleration may be used in the conditional judgment, or both force and acceleration may be used in the conditional judgment. As illustrated in FIG. 7, when operation is started (S110), the control section 110 takes a state in which the arm section 3303 is stopped (S120). Next, a sensor value is measured by the force sensor 151 or the torque sensor 152 (S121).

Next, in the case in which some or all of a condition that an external force has occurred in a predetermined part of the arm section 3303, a condition that the relationship between the magnitude (F) of the external force and threshold values (α and β) satisfies a predetermined relationship (α<F<β), and a condition that the change in the magnitude and direction of the external force is gradual do not hold (“NO” in S122), the control section 110 locks the arm section 3303 (S142), and causes operation to proceed to S120. On the other hand, in the case in which all of these conditions are satisfied, the control section 110 moves the arm section 3303 (S142), and causes operation to proceed to S130.

Note that the predetermined part of the arm section 3303 is not particularly limited, and is sufficiently a position which has a high probability of being touched directly when a scopist operates the arm section 3303. When a state of the arm section 3303 moving is reached (S130), a sensor value is measured by the force sensor 151 or the torque sensor 152, and a sensor value is measured by the encoder 154 or the speed sensor 155 (S131). Also, in the case in which the magnitude (F) of the external force is α or less, it is conceivable that an unintentional small force (noise) has been imparted to the arm section 3303. Also, in the case in which the magnitude (F) of the external force is β or greater, it is conceivable that an unintentional strong force (such as a collision with the arm section 3303 by someone on the medical team) has been imparted to the arm section 3303.

Next, in the case in which some or all of the condition that an external force has occurred in a predetermined part of the arm section 3303, the condition that the relationship between the magnitude (F) of the external force and threshold values (α and β) satisfies a predetermined relationship (α<F<β), and a condition that the relationship between the speed (S) and threshold values (θ and γ) satisfies a predetermined relationship (θ<S<γ) do not hold (“NO” in S132), the control section 110 locks the arm section 3303 (S142), and causes operation to proceed to S120. On the other hand, in the case in which all of these conditions are satisfied, the control section 110 moves the arm section 3303 (S142), and causes operation to proceed to S130.

Note that in the case in which the speed (S) is θ or less, it is assumed that the speed of the arm section 3303 is too low (for example, a case is assumed in which, when the scopist lets go of the arm section 3303, the arm section 3303 has a low speed, but the arm section 3303 should be stopped). Also, in the case in which the speed (S) is γ or greater, it is assumed that the speed of the arm section 3303 is too large (for example, a case is assumed in which someone on the medical team has accidentally pushed the arm section 3303).

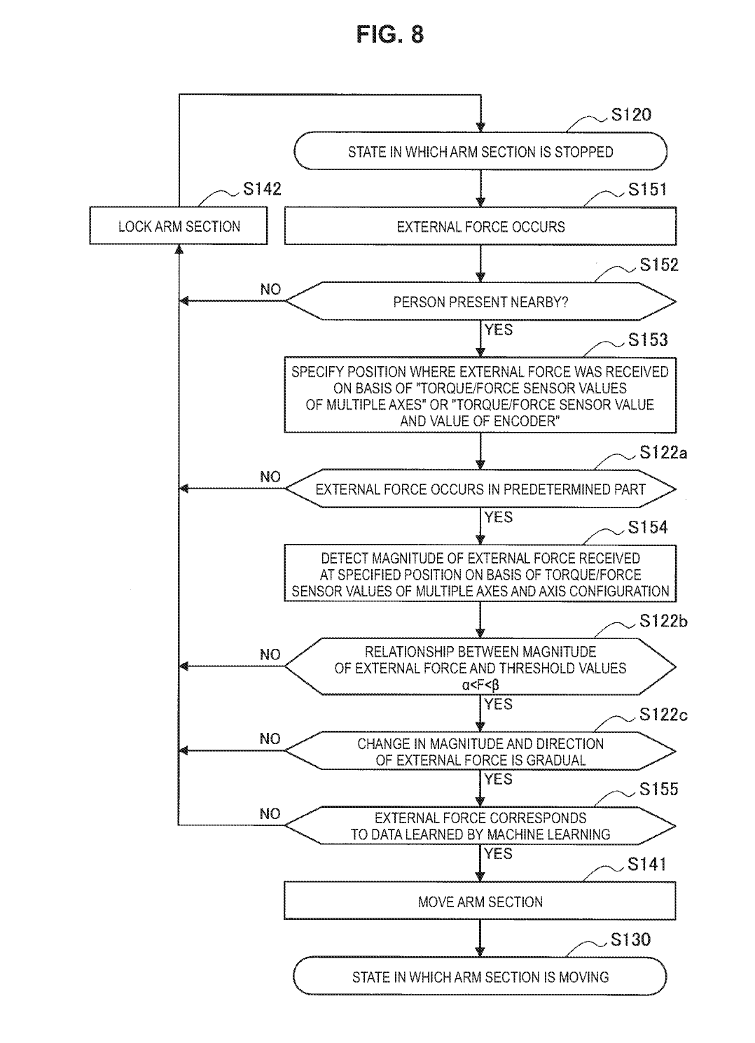

FIG. 8 is a flowchart illustrating a detailed example of operations from the state S120 in which the arm section 3303 is stopped to the state S130 in which the arm section 3303 is moving. As illustrated in FIG. 8, when the arm section 3303 is in a stopped state (S120), an external force on the arm section 3303 occurs (S151). At this time, in the case in which a person is not present nearby (“NO” in S152), the control section 110 locks the arm section 3303 (S142), and causes operation to proceed to S120. Note that whether or not a person is present nearby may be determined on the basis of a sensor value by the human presence detection section 156.

On the other hand, in the case in which a person is present nearby (“YES” in S152), the control section 110 specifies the position where the external force was received, on the basis of “sensor values by the torque sensors 152 of multiple axes (joint sections 3305a to 3305f) or sensor values by the force sensors 151 of multiple axes (joint sections 3305a to 3305f)” or “a sensor value by the torque sensor 152 or a sensor value by the force sensor 151 and a value of the encoder 154” (S153).

Note that the position where the external force was received may be specified in any way. For example, the control section 110 may specify the position where the external force was received on the basis of a comparison of sensor values by the torque sensors 152 of multiple axes (joint sections 3305a to 3305f) or sensor values by the force sensors 151 of multiple axes (joint sections 3305a to 3305f). Alternatively, the control section 110 may specify the position where the external force was received with even higher accuracy by an estimation using the internal model described above.

Next, in the case in which an external force does not occur in a predetermined part of the arm section 3303 (“NO” in S122a), the control section 110 locks the arm section 3303 (S142), and causes operation to proceed to S120. On the other hand, in the case in which an external force occurs in a predetermined part of the arm section 3303 (“YES” in S122a), the control section 110 detects the magnitude of the external force received at the specified position, on the basis of sensor values by the torque sensors 152 of multiple axes (joint sections 3305a to 3305f) or sensor values by the force sensors 151 of multiple axes (joint sections 3305a to 3305f) and the axis configuration (S154).

Next, in the case in which the relationship between the magnitude (F) of the external force and the threshold values (α and β) does not satisfy the predetermined relationship (α<F<β) (“NO” in S122b), the control section 110 locks the arm section 3303 (S142), and causes operation to proceed to S120. On the other hand, in the case in which the relationship between the magnitude (F) of the external force and the threshold values (α and β) satisfies the predetermined relationship (α<F<β) (“YES” in S122b), the control section 110 causes operation to proceed to S122c.

Next, in the case in which the change in at least one of the magnitude of the external force and the direction of the external force is not gradual (“NO” in 122c), the control section 110 locks the arm section 3303 (S142), and causes operation to proceed to S120. On the other hand, in the case in which the change in both the magnitude of the external force and the direction of the external force is gradual (“YES” in S122c), the control section 110 causes operation to proceed to S155.

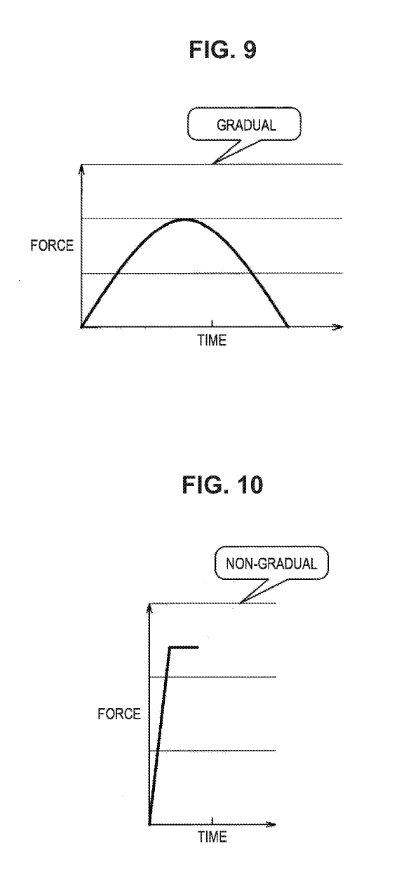

The gradual case and the non-gradual case of the change in the magnitude of the external force will be described. FIG. 9 is a diagram illustrating an example of the case in which the change in the magnitude of the external force is gradual. As illustrated in FIG. 9, in the case in which the change in the magnitude of the external force is gradual, the magnitude of the external force changes gently over time. Consequently, in the case in which the absolute value of the value obtained by time-differentiating the magnitude of the external force falls below a predetermined value, the control section 110 may determine that the change in the magnitude of the external force is gradual.

FIG. 10 is a diagram illustrating an example of the case in which the change in the magnitude of the external force is non-gradual. As illustrated in FIG. 10, in the case in which the change in the magnitude of the external force is non-gradual, the magnitude of the external force changes suddenly over time. Consequently, in the case in which the absolute value of the value obtained by time-differentiating the magnitude of the external force rises above a predetermined value, the control section 110 may determine that the change in the magnitude of the external force is non-gradual.

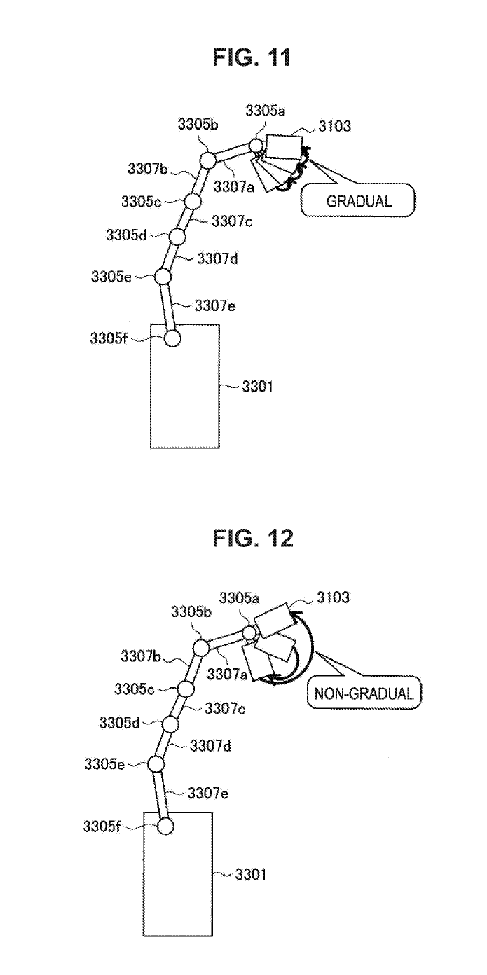

FIG. 11 is a diagram illustrating an example of the case in which the change in the direction of the external force is gradual. As illustrated in FIG. 11, in the case in which the change in the direction of the external force is gradual, the direction of the external force changes gently over time. Consequently, in the case in which the absolute value of each value obtained by time-differentiating the components of a vector indicating the direction of the external force falls below a predetermined value, the control section 110 may determine that the change in the direction of the external force is gradual.

FIG. 12 is a diagram illustrating an example of the case in which the change in the direction of the external force is non-gradual. As illustrated in FIG. 12, in the case in which the change in the direction of the external force is non-gradual, the direction of the external force changes suddenly over time. Consequently, in the case in which the absolute value of any value obtained by time-differentiating the components of a vector indicating the direction of the external force rises above a predetermined value, the control section 110 may determine that the change in the direction of the external force is non-gradual.

The description will return to FIG. 8 and proceed. By the advance input of multiple combinations of external forces and data indicating whether or not to lock the arm section 3303, through machine learning the control section 110 is enabled to output data indicating whether or not to lock the arm section 3303 in correspondence with an input external force. Accordingly, in the case in which the external force does not correspond to data learned by machine learning (“NO” in S155), the control section 110 locks the arm section 3303 (S142), and causes the operation to proceed to S120. On the other hand, in the case in which the external force corresponds to data learned by machine learning (“YES” in S155), the control section 110 moves the arm section 3303 (S141) and puts the arm section 3303 into a moving state (S130).

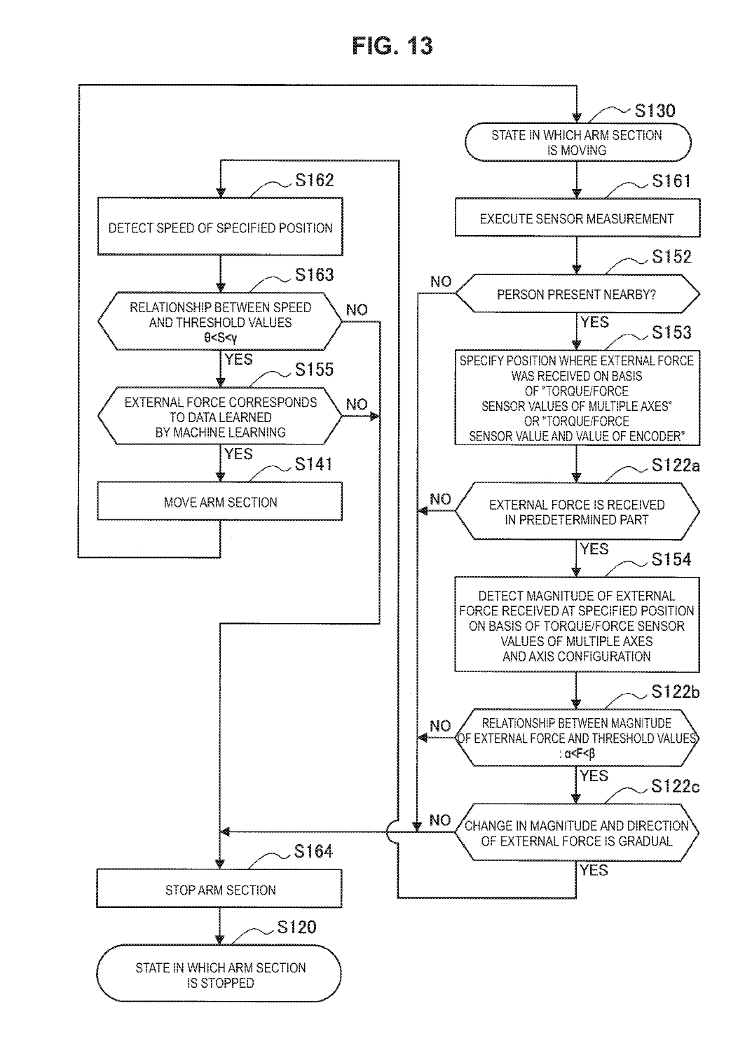

FIG. 13 is a flowchart illustrating a detailed example of operations from the state S130 in which the arm section 3303 is moving to the state S120 in which the arm section 3303 is stopped. As illustrated in FIG. 13, when the arm section 3303 is in a moving state (S130), sensor measurement by the detection section 150 is performed (S161). At this time, in the case in which a person is not present nearby (“NO” in S152), the control section 110 stops the arm section 3303 (S164), and the arm section 3303 enters the stopped state (S120).

On the other hand, in the case in which a person is present nearby (“YES” in S152), the control section 110 specifies the position where the external force was received, on the basis of “sensor values by the torque sensors 152 of multiple axes (joint sections 3305a to 3305f) or sensor values by the force sensors 151 of multiple axes (joint sections 3305a to 3305f)” or “a sensor value by the torque sensor 152 or a sensor value by the force sensor 151 and a value of the encoder 154” (S153).

Next, in the case in which an external force does not occur in a predetermined part of the arm section 3303 (“NO” in S122a), the control section 110 stops the arm section 3303 (S164), and the arm section 3303 enters the stopped state (S120). On the other hand, in the case in which an external force occurs in a predetermined part of the arm section 3303 (“YES” in S122a), the control section 110 detects the magnitude of the external force received at the specified position, on the basis of sensor values by the torque sensors 152 of multiple axes (joint sections 3305a to 3305f) or sensor values by the force sensors 151 of multiple axes (joint sections 3305a to 3305f) and the axis configuration (S154).

Next, in the case in which the relationship between the magnitude (F) of the external force and the threshold values (α and β) does not satisfy the predetermined relationship (α<F<β) (“NO” in S122b), the control section 110 stops the arm section 3303 (S142), and the arm section 3303 enters the stopped state (S120). On the other hand, in the case in which the relationship between the magnitude (F) of the external force and the threshold values (α and β) satisfies the predetermined relationship (α<F<β) (“YES” in S122b), the control section 110 causes operation to proceed to S122c.

Next, in the case in which the change in at least one of the magnitude of the external force and the direction of the external force is not gradual (“NO” in 122c), the control section 110 stops the arm section 3303 (S164), and the arm section 3303 enters the stopped state (S120). On the other hand, in the case in which the change in both the magnitude of the external force and the direction of the external force is gradual (“YES” in S122c), the control section 110 causes operation to proceed to S162.

Next, the control section 110 detects the speed of the specified position (S162), and in the case in which the relationship between the speed (S) and the threshold values (θ and γ) does not satisfy the predetermined relationship (θ<S<γ) (“NO” in S163), the control section 110 stops the arm section 3303 (S164), and the arm section 3303 enters the stopped state (S120). On the other hand, in the case in which the relationship between the speed (S) and the threshold values (θ and γ) satisfies the predetermined relationship (θ<S<γ) (“YES” in S163), the control section 110 causes operation to proceed to S155.

Next, in the case in which the external force does not correspond to data learned by machine learning (“NO” in S155), the control section 110 stops the arm section 3303 (S164), and the arm section 3303 enters the stopped state (S120). On the other hand, in the case in which the external force corresponds to data learned by machine learning (“YES” in S155), the control section 110 moves the arm section 3303 (S141) and puts the arm section 3303 into a moving state (S130).

The above describes a configuration of the support system 1 according to the present embodiment.

### (3. Supplement)

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, although the foregoing embodiment describes a case in which the target of operation is a medical robot (particularly, an arm section of a surgical robot), the target of operation is not limited to such an example. For example, the target of operation may also be an industrial robot, a humanoid robot, or the like. Also, the foregoing embodiment illustrates an example of controlling whether to move or lock the arm section according to an inferred intention, but other control may also be executed. For example, in the case in which the intention is in line with the intention of a user operation on the target of operation, a predetermined interaction with the user may be controlled.

Also, the foregoing embodiment illustrates an example of controlling whether to move or lock the arm section according to an inferred intention, but the control section 110 may also control the output of a predetermined alarm in the case in which the intention is not in line with the intention of a user operation on the target of operation. The alarm output may be achieved by being displayed, or by being output as sound.

Also, the foregoing embodiment cites the force sensor 151, the torque sensor 152, the acceleration sensor 153, the encoder 154, and the speed sensor 155 as examples of the sensors, but the examples of the sensors are not limited to such examples. For example, in the case in which a tactile sensor is provided in the support arm apparatus 3300, a user intention may be inferred on the basis of a result of detection by the tactile sensor. Alternatively, in the case in which a pressure sensor is provided in the support arm apparatus 3300, a user intention may be inferred on the basis of a result of detection by the pressure sensor. Also, in the case in which the user wears a wearable device or the like which includes a sensor, a user intention may be inferred on the basis of a result of detection by the sensor.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A control apparatus including:

a control section that infers an intention of an external force on a basis of the external force.

(2)

The control apparatus according to (1), in which

the control section infers the intention of the external force on a basis of the external force on a predetermined target of operation.

(3)

The control apparatus according to (2), in which

the control section controls whether to move or stop the target of operation on a basis of the intention.

(4)

The control apparatus according to (2) or (3), in which

the control section controls whether to move or stop the target of operation according to whether or not a position where the external force occurs is inside a predetermined range on the target of operation.

(5)

The control apparatus according to any one of (2) to (4), in which

the control section controls whether to move or stop the target of operation according to whether or not a magnitude of the external force is inside a predetermined range.

(6)

The control apparatus according to any one of (2) to (5), in which

the control section controls whether to move or stop the target of operation according to whether or not a change in a magnitude of the external force is gradual.

(7)

The control apparatus according to any one of (2) to (6), in which

the control section controls whether to move or stop the target of operation according to whether or not a change in a direction of the external force is gradual.

(8)

The control apparatus according to any one of (2) to (7), in which

the control section controls whether to move or stop the target of operation on a basis of whether or not a presence of a human being is detected.

(9)

The control apparatus according to any one of (2) to (8), in which

the control section controls whether to move or stop the target of operation on a basis of the external force and a result of learning by machine learning.

(10)

The control apparatus according to any one of (2) to (9), in which

the control section causes a technique of inferring the intention to be different according to whether or not the target of operation is moving.

(11)

The control apparatus according to any one of (10), in which

in a case in which the target of operation is stopped, the control section controls whether or not to move the target of operation according to whether or not a rising speed of a force imparted to the target of operation is inside a predetermined range.

(12)

The control apparatus according to any one of (10), in which

in a case in which the target of operation is moving, the control section controls whether or not to move the target of operation according to whether or not a speed of the target of operation is inside a predetermined range.

(13)

The control apparatus according to any one of (2) to (12), in which

the target of operation includes a plurality of links or a plurality of joint sections, and a sensor is provided in at least the link on a front end of the plurality of links or the plurality of joint sections.

(14)

The control apparatus according to (13), in which

the target of operation includes a plurality of links or a plurality of joint sections, and a discrete sensor is provided in each of the plurality of links or the plurality of joint sections.

(15)

The control apparatus according to any one of (2) to (14), in which

in a case in which the intention is in line with an intention of a user operation on the target of operation, the control section controls a predetermined interaction with the user.

(16)

The control apparatus according to any one of (2) to (14), in which

in a case in which the intention is not in line with an intention of a user operation on the target of operation, the control section controls an output of a predetermined alarm.

(17)

The control apparatus according to any one of (1) to (16), in which

the external force includes at least one of a force, a torque, an acceleration, and a speed.

(18)

The control apparatus according to (17), in which

the acceleration is detected by an acceleration sensor, or is computed from a detection result of an encoder that detects a rotational angle of a joint section existing between links of a target of operation.

(19)

The control apparatus according to (17), in which

the speed is detected by a speed sensor, or is computed from a detection result of an encoder that detects a rotational angle of a joint section existing between links of a target of operation.

(20)

A control method including:

inferring, by a processor, an intention of an external force on a basis of the external force.

### REFERENCE SIGNS LIST

1 support system
110 control section
130 arm control section
150 detection section
151 force sensor
152 torque sensor
153 acceleration sensor
154 encoder
3000 endoscopic surgery system
3100 endoscope
3101 lens tube
3103 camera head
3200 surgical instruments
3201 pneumoperitoneum tube
3203 energy treatment tool
3205 forceps
3207a trocar
3300 support arm apparatus
3301 base section
3303 arm section
3400 cart
3401 CCU
3403 display apparatus
3405 light source apparatus
3407 arm control apparatus
3408 control apparatus
3409 input apparatus
3411 treatment tool control apparatus
3413 pneumoperitoneum apparatus
3415 recorder
3417 printer
3419 footswitch
3501 surgeon
3503 patient bed
3505 patient

1. A control apparatus comprising:
a control section that infers an intention of an external force on a basis of the external force.

2. The control apparatus according to claim 1, wherein
the control section infers the intention of the external force on a basis of the external force on a predetermined target of operation.

3. The control apparatus according to claim 2, wherein
the control section controls whether to move or stop the target of operation on a basis of the intention.

4. The control apparatus according to claim 2, wherein
the control section controls whether to move or stop the target of operation according to whether or not a position where the external force occurs is inside a predetermined range on the target of operation.

5. The control apparatus according to claim 2, wherein
the control section controls whether to move or stop the target of operation according to whether or not a magnitude of the external force is inside a predetermined range.

6. The control apparatus according to claim 2, wherein
the control section controls whether to move or stop the target of operation according to whether or not a change in a magnitude of the external force is gradual.

7. The control apparatus according to claim 2, wherein
the control section controls whether to move or stop the target of operation according to whether or not a change in a direction of the external force is gradual.

8. The control apparatus according to claim 2, wherein
the control section controls whether to move or stop the target of operation on a basis of whether or not a presence of a human being is detected.

9. The control apparatus according to claim 2, wherein
the control section controls whether to move or stop the target of operation on a basis of the external force and a result of learning by machine learning.

10. The control apparatus according to claim 2, wherein
the control section causes a technique of inferring the intention to be different according to whether or not the target of operation is moving.

11. The control apparatus according to claim 10, wherein
in a case in which the target of operation is stopped, the control section controls whether or not to move the target of operation according to whether or not a rising speed of a force imparted to the target of operation is inside a predetermined range.

12. The control apparatus according to claim 10, wherein
in a case in which the target of operation is moving, the control section controls whether or not to move the target of operation according to whether or not a speed of the target of operation is inside a predetermined range.

13. The control apparatus according to claim 2, wherein
the target of operation includes a plurality of links or a plurality of joint sections, and a sensor is provided in at least the link on a front end of the plurality of links or the plurality of joint sections.

14. The control apparatus according to claim 13, wherein
the target of operation includes a plurality of links or a plurality of joint sections, and a discrete sensor is provided in each of the plurality of links or the plurality of joint sections.

15. The control apparatus according to claim 2, wherein
in a case in which the intention is in line with an intention of a user operation on the target of operation, the control section controls a predetermined interaction with the user.

16. The control apparatus according to claim 2, wherein
in a case in which the intention is not in line with an intention of a user operation on the target of operation, the control section controls an output of a predetermined alarm.

17. The control apparatus according to claim 1, wherein
the external force includes at least one of a force, a torque, an acceleration, and a speed.

18. The control apparatus according to claim 17, wherein
the acceleration is detected by an acceleration sensor, or is computed from a detection result of an encoder that detects a rotational angle of a joint section existing between links of a target of operation.

19. The control apparatus according to claim 17, wherein
the speed is detected by a speed sensor, or is computed from a detection result of an encoder that detects a rotational angle of a joint section existing between links of a target of operation.

20. A control method comprising:
inferring, by a processor, an intention of an external force on a basis of the external force.
